(19) United States
(12) Patent Application Publication
(10) Pub. No.: US 2006/0199050 A1
(43) Pub. Date: Sep. 7, 2006

(54) Pump fixing accessory and fuel cell having the same

(76) Inventors: Sang Hyeon Choi, Yongin-si (KR); Jong Ki Lee, Yongin-si (KR); Jun Won Suh, Yongin-si (KR); Won Hyouk Jang, Yongin-si (KR); Dong Yun Lee, Yongin-si (KR); Ri A Ju, Yongin-si (KR); Eun Suk Cho, Yongin-si (KR); Jin Hong An, Yongin-si (KR)

Correspondence Address: Robert E. Bushnell, Suite 300, 1522 K Street, N.W., Washington, DC, 20005, US

(21) Appl. No.: 11/366,504

(22) Filed: Mar. 3, 2006

(30) Foreign Application Priority Data
Mar. 4, 2005 (KR) 2005-17967

(51) Int. Cl. H01M 8/00

(52) U.S. Cl. 429/13

(57) ABSTRACT

A fuel cell system comprises an electricity generation section for generating electrical energy through electrochemical reaction of hydrogen and oxygen, a fuel supply section including a fuel pump arranged in a fuel tank for providing fuel, an oxidizer supply section including an oxidizer supply pump for providing an oxidizer to the electricity generation section, and a pump fixing accessory for connecting the fuel pump and the oxidizer supply pump to the body plate of a fuel cell, and for absorbing vibration generated by driving of one of both pumps. The pump fixing accessory comprises a vibration absorbing section for absorbing the vibration generated by the driving of the pump(s), a first connection section having one end connected to the vibration absorbing section and another end connected to the pump(s), and a second connection section having one end connected to the vibration absorbing section and another end connected to the body plate of the fuel cell.

### CLAIM OF PRIORITY

This application makes reference to, incorporates the same herein, and claims all benefits accruing under 35 U.S.C. § 119 from an application for PUMP FIXING ACCESSARY AND FUEL CELL HAVING THE SAME earlier filed in the Korean Intellectual Property Office on the 4^{th} Mar. 2005 and there, duly assigned Serial No. 10-2005-0017967.

### BACKGROUND OF THE INVENTION

1. Technical Field

The present invention relates to a pump fixing accessory and a fuel cell system using the pump fixing accessory, and in particular, relates to a pump fixing accessory with structure for reducing the noise generated in an air pump or a fuel pump, and a fuel cell system using the pump fixing accessory.

2. Discussion of the Related Art

The fuel cell is a system which converts chemical reaction energy of hydrogen and oxygen into an electrical energy. Hydrogen is contained in material belonging to the hydrocarbon group, such as methanol, ethanol and natural gases. The fuel cell is classified into a fuel cell of a high temperature type and a fuel cell of a low temperature type according to the operation temperature.

Of these, the Direct Liquid Feed Fuel Cell (DLFC) and the Polymer Electrolyte Membrane Fuel Cell (PEMFC) can be enumerated as fuel cells of the low temperature type. When a DLFC uses methanol as a fuel, it is called as Direct Methanol Fuel Cell (DMFC).

Since the PEMFC exhibits excellent output characteristics, is operated at a low temperature, and has swift starting and response features, there is an advantage in that it can be widely used as a distributed power source for houses and public buildings, and as a small power source for electronic equipment as well as a mobile power source for vehicles.

The fuel cell system employing the PEMFC type is composed of a stack, a reformer, a fuel tank, a fuel pump, and an air pump. The stack forms an electricity generation group which includes a plurality of unit cells, and the fuel pump supplies fuel from the fuel tank to the reformer. The reformer reforms the fuel into hydrogen gas, and supplies the gas to the stack. Then, in the stack, the hydrogen gas electrochemically reacts with oxygen contained in the air, and generates electrical energy.

On the other hand, since the DMFC uses liquid methanol directly as a reaction fuel instead of hydrogen gas, it is not necessary to prepare the fuel reformer. Therefore, in the case of employing the DMFC, the size of the fuel cell can be miniaturized, and it is possible to store and manage fuel with ease. In addition, the DMFC can be widely used in such fields as pollution-free vehicles, power generation systems for houses, mobile communication equipment, medical equipment, military equipment, and space development equipment.

In the above-mentioned fuel cell system, the stack generating electricity comprises several or tens of unit cells, each of which includes a membrane-electrode assembly (MEA) and separators (bipolar plates) in a stacked state. In this regard, the MEA has a structure in which an anode electrode and a cathode electrode are attached with an electrolyte layer being arranged therebetween. In addition, the separator provides hydrogen gas and air to the MEA, and also functions as a conductor for allowing the anode electrode and the cathode electrode of each MEA to be connected serially. Accordingly, while hydrogen gas is provided to the anode electrode by the separator, air is provided to the cathode electrode. During this process, oxidization of the hydrogen gas takes place at the anode electrode, and deoxidization of the oxygen takes place at the cathode electrode. At this point, electricity, heat and water can be obtained due to movement of the generated electrons.

In such a fuel cell system, each of the devices, such as the stack, the fuel pump and the air pump, are arranged at predetermined positions in the interior of the case of a fuel cell, and the devices are packaged.

However, according to such a fuel cell system, noise and vibration are generated due to the driving of the fuel pump and the air pump.

In this respect, the noise is generated mainly by rotation of a motor or pressure in the pump, and the vibration consists of top and bottom movement or left and right movement generated by rotation of the motor or pressure in the pump. A large amount of noise is generated since the vibration is transferred to the case of the fuel cell.

The noise and the vibration generated in the fuel cell hinder normal operation of the fuel cell, and thus the life span of the fuel cell may be shortened.

Furthermore, if the field of application is expanded to small-sized mobile devices, such as a notebook computer, a portable DVD player, a PDA, a mobile phone and a camcorder, since the noise and the vibration of the fuel cell cause much inconvenience to the user, the noise generation of a fuel cell must be prevented.

### SUMMARY OF THE INVENTION

The present invention is provided in order to solve the latter problems. The object of the present invention is to provide a fuel cell comprising a pump fixing accessory which can provide convenience to the user in using the fuel cell by mitigating noise by absorbing the vibration generated by the driving of a fuel pump or an air pump.

In order to achieve the foregoing objects, a pump fixing accessory according to the present invention comprises a vibration absorbing section for absorbing the vibration generated by driving of a pump, a first connection section having one end connected to the vibration absorbing section and another end connected to the pump, and a second connection having one end connected to the vibration absorbing section and another end connected to a body plate of a fuel cell.

It is preferable that the vibration absorbing section be formed by an elastic member having a predetermined elasticity, and be formed in a cylindrical shape.

Furthermore, the vibration absorbing section may be made of rubber.

The first connection section and the second connection section preferably comprise a head section fixed to the vibration absorbing section, and a screw section which can be connected to the pump or the body plate of the fuel cell. The first connection section and the second connection section are connected by a screw.

In the latter regard, the first connection section and the second connection section are fixed so that the head section may be arranged symmetrically in opposite directions at both ends of the vibration absorbing section. In this case, the head sections of the first connection section and the second connection section may be inserted into the vibration absorbing section by a predetermined distance.

Furthermore, the first connection section and the second connection section are fixed so that they may be arranged symmetrically in opposite directions at the vibration absorbing section, and the first connection section and the second connection section are fixed with a predetermined gap therebetween.

According to the present invention, in order to achieve the foregoing objects, the fuel cell system comprises an electricity generation section for generating electrical energy through an electrochemical reaction of hydrogen and oxygen, a fuel supply section including a fuel pump arranged in a fuel tank for providing fuel, an oxidizer supply section including an oxidizer supply pump for providing an oxidizer to the electricity generation section, and a pump fixing accessory for connecting the fuel pump and the oxidizer supply pump to the body plate of the fuel cell, and for absorbing vibration generated by driving of the fuel pump and/or oxidizer supply pump, wherein the pump fixing accessory comprises a vibration absorbing section for absorbing the vibration generated by driving of the pump, a first connection section having one end connected to the vibration absorbing section and another end connected to the pump, and a second connection having one end connected to the vibration absorbing section and another end connected to a body plate of a fuel cell.

According to the present invention, such a fuel cell system comprises a recycle tank for collecting fuel which shows no reaction in the electricity generation section, and for recycling it, and a mixing tank for mixing and supplying the fuel of the fuel tank and the fuel of low density in the recycle tank.

Furthermore, the fuel supply section is arranged between the fuel tank and the electricity generation section so that it generates hydrogen gas after receiving fuel from the fuel tank, and comprises a means for supplying hydrogen gas to the electricity generation section.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram schematically showing the structure of a fuel cell system according to the present invention.

FIG. 2 is a perspective view showing a first embodiment of a pump fixing accessory according to the present invention.

FIG. 3 is a front view showing a first embodiment of a pump fixing accessory according to the present invention.

FIG. 4A is a perspective view showing a pump fixing accessory of the present invention.

FIG. 4B is a perspective view showing a fuel cell having the pump fixing accessory according to the present invention.

FIG. 5 is a cross-sectional view showing the essential elements of a fuel cell having a pump fixing accessory according to a first embodiment of the present invention.

FIG. 6 is a cross-sectional view showing the essential elements of a fuel cell having a pump fixing accessory according to a second embodiment of the present invention.

FIG. 7 is a front view showing a pump fixing accessory according to a third embodiment of the present invention.

### DETAILED DESCRIPTION OF THE INVENTION

Below, embodiments of the present invention will be described in detail by referring to the attached drawings so that they may be implemented by those skilled in the art to which the present invention pertains. However, the present invention may be realized as various different types, and is not limited to the embodiments explained herein.

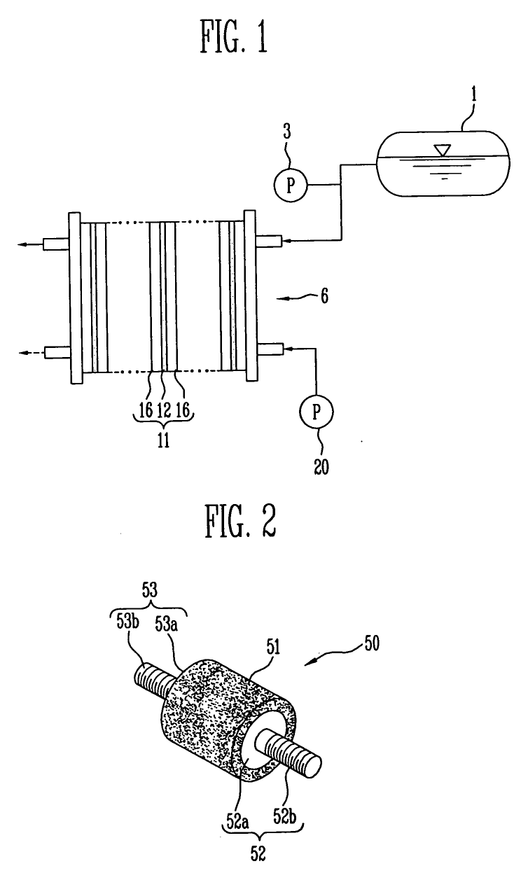

FIG. 1 is a block diagram schematically showing the structure of a fuel cell system according to the present invention.

Referring to FIG. 1, a fuel cell system according to the present invention will be explained. This fuel cell system employs a DMFC type fuel cell which provides fuel to a stack directly, and which can produce electricity.

In this fuel cell system, the fuel for generating the electricity is methanol.

Furthermore, the fuel cell system may use pure oxygen gas stored in an additional storage means as oxygen which reacts with hydrogen, or may use air which includes oxygen as it is. Below, the latter case will be explained.

The fuel cell system of the present invention comprises an electricity generation section 11 for generating electrical energy through an electrochemical reaction of hydrogen and oxygen, a fuel supply source for supplying the fuel to the electricity generation section 11, and an oxygen supply source for supplying the oxygen to the electricity generation section 11.

The electricity generation section 11 is connected to the fuel supply source, and thus the fuel (for example, methanol) is supplied to the section 11 from the fuel supply source. The section 11 is composed of a fuel cell of a minimum unit which generates electrical energy through an electrochemical reaction of hydrogen and oxygen of the fuel when oxygen is supplied from an oxygen supply source. This electricity generation section 11 is designed such that an MEA 12 is arranged in the center, and separators 16 (called “Bipolar Plates” in the art) are arranged on both sides of the MEA 12. It is possible to form a stack 6, which is a group of electricity generation sections 1, by preparing a plurality of electricity generation sections 11, and then arranging the electricity generation sections 11 sequentially.

The fuel supply source includes a first tank 1 for storing liquid fuel, and a fuel pump 3 connected to the first tank 1.

Furthermore, the oxygen supply source absorbs air by using predetermined pumping power, and includes an air supply pump to provide air to the electricity generation section 11.

In order to operate the fuel cell system of the present invention as described above, the fuel supplied from the fuel pump 3, and the air absorbed by the air pump 20, are supplied to the electricity generation section 11, and the electricity generation section 11 then generates electricity, together with water and heat, through an electrochemical reaction of hydrogen in the fuel and oxygen contained in the air.

The fuel cell system of the present invention may further comprise a recycle tank (not shown) for collecting and recycling un-reacted fuel from the stack 6, and a mixing tank (not shown) for mixing and supplying the high density fuels of the first tank 1 and the low density fuel in the recycle tank (not shown).

Furthermore, the fuel cell system according to the present invention reforms the fuel, including the hydrogen as described above, and thereby generates hydrogen gas. In addition, the system may employ a PEMFC type fuel cell which generates electrical energy through an electrochemical reaction of hydrogen gas and oxygen. This PEMFC needs a reformer, unlike the above-mentioned DMFC.

In the fuel cell system according to the present invention, the air pump 20 or the fuel pump 3 are fixed directly to the case of the fuel or to a separate plate, and are packaged. In this case, a pump fixing accessory is arranged between the air pump 20 or the fuel pump 3 and the plate for preventing noise by absorbing the vibration generated due to pump operations.

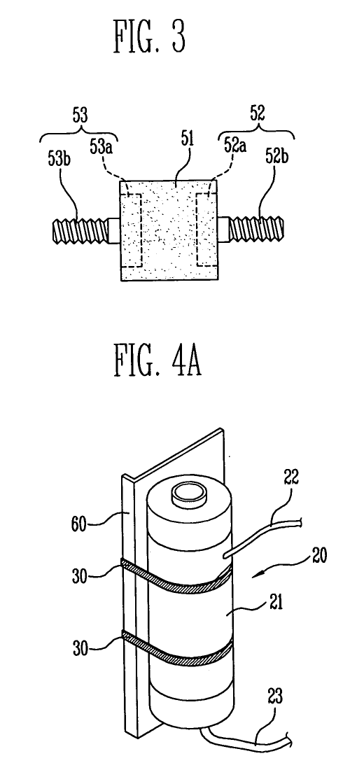

FIG. 2 is a perspective view showing a first embodiment of a pump fixing accessory according to the present invention, and FIG. 3 is a front view showing the first embodiment of a pump fixing accessory according to the present invention.

A pump fixing accessory 50 according to the present invention comprises a vibration absorbing section 51 for absorbing the vibration generated by the driving of the air pump 20 or the fuel pump 3, a first connection section 52 which is fixed to one end of the vibration absorbing section 51 so as to connect with the pump 3 or the pump 20, and a second connection 53 which is fixed to the other end of the vibration absorbing section 51 so as to connect with a body plate of a fuel cell.

In this respect, the vibration absorbing section 51 comprises an elastic member having a predetermined elasticity for absorbing the vibration of the pump.

Various kinds of materials, such as elastic rubber, plastic resin of a soft material, and the like, may be used as the elastic member. It is preferable that elastic rubber be used, but the present invention is not limited to this material.

Furthermore, in the embodiment of the present invention, screws may be used instead of the first connection section 52 and the second connection section 53.

For example, each of the first connection section 52 and the second connection section 53 is a screw which is composed of a head section 52a, 53a fixed to the vibration absorbing section 51, and a screw section 52b, 53b which can be connected to one of the pump 3 or pump 20 and a body plate of the fuel cell, respectively. The first connection section 52 and the second connection section 53 are connected to the pumps 3, 20 and a body plate of the fuel cell by screw sections 52b, 53b.

In the latter regard, the first connection section 52 and the second connection section 53 of the first embodiment of the present invention are fixed so that the head sections 52a, 53a may be arranged symmetrically in opposite directions at both ends of the vibration absorbing section 51, and the first connection section 52 and the second connection section 53 are inserted into the vibration absorbing section 51 by a predetermined distance, and then fixed to it.

That is, the head sections 52a, 53a of the first connection section 52 and the second connection section 53 are inserted into the vibration absorbing section 51 by a predetermined distance, and the screw sections 52b, 53b are projected at one end and the other end of the vibration absorbing section 51.

The head sections 52a, 53a of the first connection section 52 and the second connection section 53 are adhered and fixed by an adhesive at both ends of the vibration absorbing section 51. In this case, the head sections 52a, 53a are adhered by forming a groove (not shown) having a size which is same to the outer diameter of the head sections 52a, 53a at both ends of the vibration absorbing section 51.

Furthermore, since the vibration absorbing section 51 is composed of elastic rubber, and a plastic resin of a soft material, in the case of forming the vibration absorbing section 51, an integral shape can be realized by inserting the head sections 52a, 53a of the first connection section 52 and the second connection section 53 into the vibration absorbing section 51 by a predetermined distance.

In the pump fixing accessory 50 according to the present invention, when the direction of the screw thread of the screw sections 52b, 53b is changed inversely, and then rotates the pump fixing accessory 50 in one direction, the screw sections 52b, 53b are connected at the same time.

That is, since one end of the first connection section 52 is connected to the air pump 20 or the fuel pump 3, and the other end of the second connection section 53 is connected to a case of the fuel or to an additionally arranged plate, it is possible to fix the air pump 20 or the fuel pump 3 to the plate.

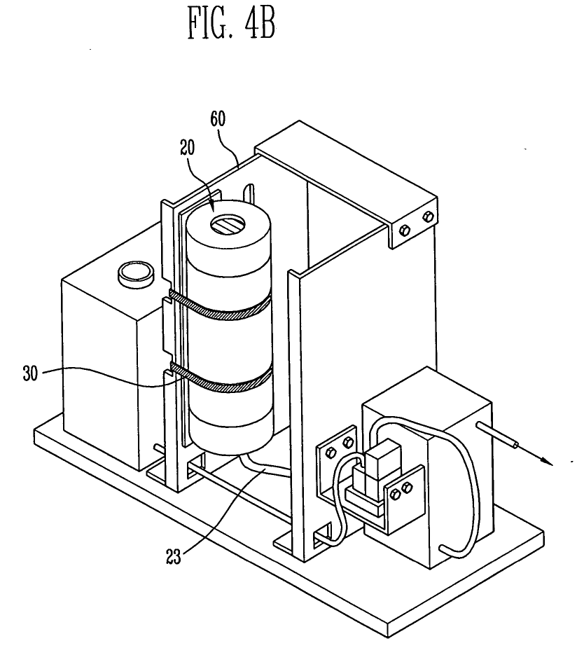

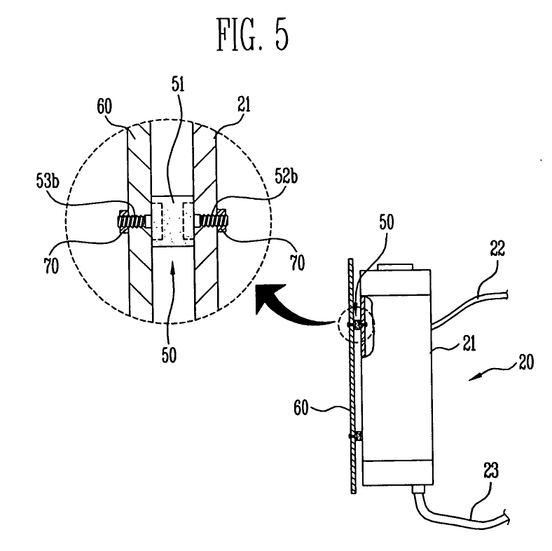

FIG. 4A is a perspective view showing a pump fixing accessory of the present invention, while FIG. 4B is a perspective view showing a fuel cell having the pump fixing accessory according to the present invention, and FIG. 5 is a cross-sectional view showing the essential elements of a fuel cell having a pump fixing accessory according to a first embodiment of the present invention.

In particular, FIGS. 4A, 4B and 5 show a state in which the air pump 20, which absorbs air and provides the air to the stack 6, is connected to a body plate 60 of the fuel cell.

In the drawings, a structure in which the air pump 20 of a cylindrical shape is connected vertically to a body plate 60 of the fuel cell is shown as an example. However, in the present invention, the pump is not limited to the air pump 20 of cylindrical shape, and it is natural that the structure can be applied when fixing the fuel pump as well as the air pump 20.

Furthermore, the air pump 20 may be arranged on the plate (not shown) forming the upper side or the lower side of a case of the fuel. In this case, the pump fixing accessory 50 of the present invention can be applied.

The air pump 20 includes an outer pipe 21 of a cylindrical shape. A wire 22 for supplying power is arranged, and a discharge pipe 23 for supplying air introduced in the upward direction to the stack 6 is connected to the lower side.

In this way, the air pump 20 is connected to the plate 60 by the pump fixing accessory 50. As is shown in FIG. 5, since the screw section 52b of the first connection section 52 of the pump fixing accessory 50 is connected to an outer pipe 21 of the air pump 20 by a screw, and the screw section 53b of the second connection section 53 is connected to the plate 60 by a screw, the air pump 20 can be fixed to the plate 60.

In this case, since the head sections 52a, 53a of the first connection section 52 and the second connection section 53 of the pump fixing accessory 50, and the vibration absorbing section 51, are inserted between the plate 60 and the air pump 20, the air pump 20 is spaced slightly away from the plate 60.

Furthermore, a screw hole (not shown) into which the screw section 53b is connected is formed on the plate 60, and a screw hole (not shown) into which the screw section 52b of the first connection section 52 is connected is also formed on an outer pipe 21 of the air pump 20.

A nut 70 is connected to the screw section 52b of the first connection section 52 and the screw section 53b of the second connection section 53 in order to securely maintain the connection of the pump fixing accessory 50.

It is preferable that the pump fixing accessory 50 be fixed to the upper side and the lower side of the air pump 20. If necessary, it is possible to arrange the pump fixing accessory 50 in a different way.

In this way, as is shown in FIGS. 4A and 4B, the air pump 20 which is fixed to the plate 60 by the pump fixing accessory 50 may be arranged on the plate 60 by winding the pressure band 30 so that the air pump 20 is fixed to the plate 60 more securely.

In the fuel cell system of the present invention as described above, even when the devices start to operate, and then vibration of the air pump 20 is generated, since the air pump 20 and the plate 60 are spaced apart by the pump fixing accessory 50, the vibration of the air pump 20 is not transmitted to the plate 60, thereby preventing noise from being generated.

Furthermore, since the vibration absorbing section 51 having an elasticity is arranged in the center of the pump fixing accessory 50, even if the first connection section 52 is swayed by the vibration of the air pump 20, the vibration absorbing section 51 absorbs the vibration, and the vibration is not transmitted to the plate 6, thereby substantially reducing noise generated due to vibration of the pump.

The pump fixing accessory 50 according to the present invention can be applied to the PEMFC and DMFC type fuel cells.

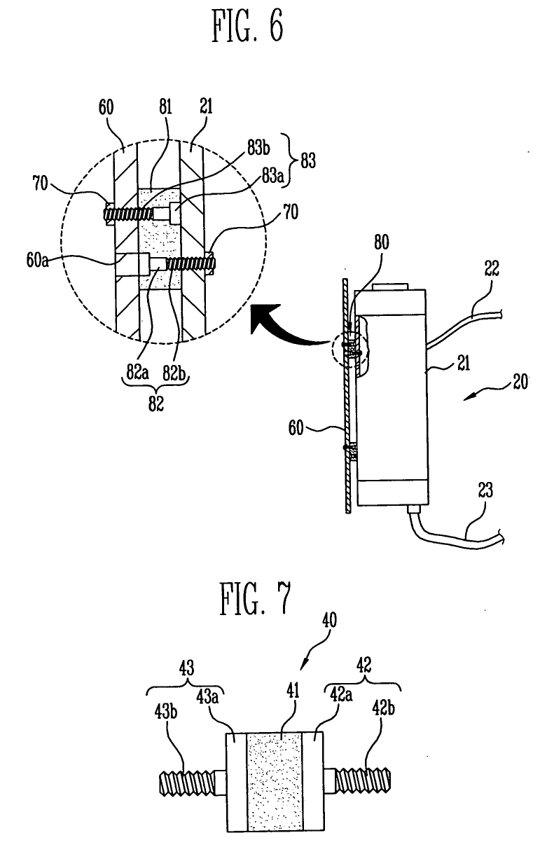

On the other hand, FIG. 6 is a cross-sectional view showing the essential elements of a fuel cell having a pump fixing accessory according to a second embodiment of the present invention. Referring to FIG. 6, the pump fixing accessory 80 is composed of a vibration absorbing section 81 for absorbing the vibration generated by driving of a pump or pumps, a first connection section 82 having one end connected to the vibration absorbing section 80, and the other end connected to the pump 20, and a second connection 83 having one end connected to the vibration absorbing section 80, and the other end connected to a body plate 60 of a fuel cell.

In this respect, the vibration absorbing section 81 is an elastic member having a predetermined elasticity, and an elastic rubber, a plastic resin of a soft material or the like may be used as the elastic member. It is preferable that it be formed in a cylindrical shape.

Furthermore, each of the first connection section 82 and the second connection section 83 is a screw which is composed of a head section 82a, 83a fixed to the vibration absorbing section 81, and a screw section 82b, 83b which can be connected to the pump 20 and a body plate 60 of the fuel cell. The first connection section 82 and the second connection section 83 are connected to the pump 20 and a body plate 60 of the fuel cell by a screw.

In this respect, the first connection section 82 and the second connection section 83 are fixed so that the head sections 82a, 83a can be arranged symmetrically in opposite directions at the vibration absorbing section 81, and the first connection section 82 and the second connection section 83 are fixed with a predetermined distance therebetween.

Furthermore, a screw hole (not shown) for connecting the screw section 83b and an insertion hole for inserting the first connection section 82 are formed on the plate 60, and a screw hole (not shown) for connecting the screw section 82b of the first connection section 82 is formed on the outer pipe 21 of the air pump 20.

First, the plate 60 is connected to the second connection section 83 by the pump fixing accessory 80 using a screw, and then the first connection section 82 is connected to the outer pipe 21 of the air pump 20. Thus, the air pump 20 is fixed to the plate 60.

A nut 70 is connected to the screw section 82b of the first connection section 82 and the screw section 83b of the second connection section 83 in order to securely maintain the connection of the pump fixing accessory.

In this way, even if vibration is generated by the driving of the air pump 20, the vibration of the air pump 20 is not transmitted to the plate 60 because the vibration absorbing section 81 having elasticity absorbs the vibration. Therefore, it is possible to reduce noise tremendously. Consequently, the second embodiment of the present invention can have the same effects as the first embodiment.

FIG. 7 is a front view showing a pump fixing accessory according to a third embodiment of the present invention. The third embodiment is composed of a vibration absorbing section 41 for absorbing vibration generated by driving of a pump or pumps, a first connection section 42 connected to one end of the vibration absorbing section 41 for connecting the vibration absorbing section 41 to the pump or pumps, and a second connection section 43 connected to the other end of the vibration absorbing section 41 for connecting the vibration absorbing section 41 to a body plate of a fuel cell.

In this respect, the vibration absorbing section 41 is an elastic member having a predetermined elasticity. it is preferable that an elastic rubber, a plastic resin of a soft material or the like be used, and that it be formed in a cylindrical shape.

Furthermore, the first connection section 42 and the second connection section 43 are screws which are composed of head sections 42a, 43a fixed to the vibration absorbing section 41, and screw sections 42b, 43b connected to the pump, and the body plate of the fuel cell. They are connected to the pump, and to the body plate of the fuel cell, by a screw.

It is preferable that the vibration absorbing section 41 be formed in a cylindrical shape having a same diameter as that of the head sections 42a, 43a of the first connection section 42 and the second connection section 43.

In this case, the head sections 42a, 43a of the first connection section 42 and the second connection section 43 may be adhered to the vibration absorbing section 41 by adhesive.

In this way, as in the other embodiments, even if vibration is generated by the driving of the air pump 20, the third embodiment of the present invention reduces noise remarkably since vibration absorbing section 41 having a predetermined elasticity absorbs the vibration.

According to the present invention, an advantageous result is achieved in that the operational environment of the fuel cell is improved remarkably since noise is reduced by absorbing vibration generated by the driving of the air pump or the fuel pump.

Although embodiments of the present invention have been shown and described, it will be appreciated by those skilled in the art that changes may be made in these embodiments without departing from the principles and the spirit of the invention, the scope of which is defined in the claims and their equivalents.

What is claimed is:

1. A pump fixing accessory, comprising:
a vibration absorbing section for absorbing vibration generated by driving of a pump;
a first connection section having one end connected to said vibration absorbing section and another end connected to said pump; and
a second connection section having one end connected to said vibration absorbing section, and another end connected to a body plate of a fuel cell.

2. The pump fixing accessory of claim 1, wherein said vibration absorbing section comprises an elastic member having a predetermined elasticity.

3. The pump fixing accessory of claim 2, wherein said vibration absorbing section is formed in a cylindrical shape.

4. The pump fixing accessory of claim 3, wherein said vibration absorbing section is made of rubber.

5. The pump fixing accessory of claim 2, wherein said vibration absorbing section is made of rubber.

6. The pump fixing accessory of claim 1, wherein each of said first connection section and said second connection section comprises a head section fixed to said vibration absorbing section and a screw section connected to one of said pump and said body plate of said fuel cell; and
wherein said first connection section and said second connection section are connected by a screw.

7. The pump fixing accessory of claim 6, wherein said first connection section and said second connection section are fixed so that said head sections may be arranged symmetrically in opposite directions at respective ends of said vibration absorbing section.

8. The pump fixing accessory of claim 7, wherein each of said first connection section and said second connection section is inserted into said vibration absorbing section by a predetermined distance, and is then fixed to said vibration absorbing section.

9. The pump fixing accessory of claim 6, wherein said first connection section and said second connection section are fixed so as to be arranged symmetrically in respective opposite directions at said vibration absorbing section; and
wherein each of said first connection section and said second connection section is fixed with a predetermined gap therebetween.

10. A fuel cell system, comprising:
at least one electricity generation section for generating electrical energy through an electrochemical reaction of hydrogen and oxygen;
a fuel supply section including a fuel pump connected to a fuel tank for providing fuel;
an oxidizer supply section including an oxidizer supply pump for providing an oxidizer to said at least one electricity generation section; and
a pump fixing accessory for connecting said fuel pump and said oxidizer supply pump to a body plate of a fuel cell, and for absorbing vibration generated by a driving of at least one of said fuel pump and said oxidizer supply pump;
wherein said pump fixing accessory comprises a vibration absorbing section for absorbing vibration generated by the driving of said at least one of said fuel pump and said oxidizer supply pump, a first connection section having one end connected to said vibration absorbing section and another end connected to said at least one of said fuel pump and said oxidizer supply pump, and a second connection section having one end connected to said vibration absorbing section and another end connected to the body plate of the fuel cell.

11. The fuel cell system of claim 10, further comprising:
a recycle tank for collecting and recycling unreacted fuel from said at least one electricity generation section; and
a mixing tank for mixing and supplying the fuel from said fuel tank and the unreacted fuel from said recycle tank.

12. The fuel cell system of claim 11, wherein said vibration absorbing section comprises an elastic member having a predetermined elasticity.

13. The fuel cell system of claim 10, wherein said vibration absorbing section comprises an elastic member having a predetermined elasticity.

14. The fuel cell system of claim 13, wherein said vibration absorbing section has a cylindrical shape.

15. The fuel cell system of claim 13, wherein said vibration absorbing section is made of rubber.

16. The fuel cell system of claim 10, wherein each of said first connection section and said second connection section includes a head section fixed to said vibration absorbing section and a screw section which is connected to one of said pump and the body plate of the fuel cell; and
wherein said first connection section and said second connection section are connected by a screw.

17. The fuel cell system of claim 16, wherein each of said first connection section and said second connection section is fixed so that said head sections may be arranged symmetrically in opposite directions at respective ends of said vibration absorbing section.

18. The fuel cell system of claim 17, wherein each of said first connection section and said second connection section is inserted into said vibration absorbing section by a predetermined distance, and is then fixed to said vibration absorbing section.

19. The fuel cell system of claim 10, wherein said first connection section and said second connection section are fixed so as to be arranged symmetrically in respective opposite directions at said vibration absorbing section; and
wherein each of said first connection section and said second connection section is fixed with a predetermined gap therebetween.

20. The fuel cell system of claim 10, wherein said fuel supply section comprises a reformer arranged between said fuel tank and said at least one electricity generation section for generating hydrogen gas after receiving fuel from said fuel tank, and for supplying the hydrogen gas to said at least one said electricity generation section.
